(19) United States
(12) Patent Application Publication
(10) Pub. No.: US 2006/0057060 A1
(43) Pub. Date: Mar. 16, 2006

(54) Method of producing synthesis gas

(75) Inventors: Lian-Ming Sun, Villebon sur Yvette (FR); Pierre-Robert Gauthier, Fresnes (FR); Pascal Marty, Paris (FR); Catherine Denis, Champigny (FR); Raphaelle Imbault, Orsay (FR)

Correspondence Address: AIR LIQUIDE, 2700 POST OAK BOULEVARD, SUITE 1800, HOUSTON, TX, 77056, US

(73) Assignee: L'Air Liquide, Societe' Anonyme a Directoire et Conseil de Surveillance pour l'Etude, Paris, Cedex 07 (FR)

(21) Appl. No.: 10/535,501

(22) PCT Filed: Nov. 14, 2003
(86) PCT No.: PCT/FR03/50121

§ 371 Date: May 18, 2005

(30) Foreign Application Priority Data
Nov. 18, 2002 (FR) 02/14382

(51) Int. Cl. C01B 3/26

(52) U.S. Cl. 423/651

(57) ABSTRACT

A method of producing a synthesis gas which contains hydrogen and carbon dioxide. A hydrocarbon mioxture is pre-reformed to create a first mixture. The first mixture is then reformed in a catalytic ceramic membrane reactor (RCMC) with oxidizing an oxidizing mixture to form a raw synthesis gas. The oxidizing mixture contains oxygen, and the raw synthesis gas contains hydrogen, carbon monoxide, carbon dioxide, water, and an oxygen depleted mixture. Several of the process streams are also preheated. The oxidizing mixture is brought to a temperature between 871° C. and 1300° C. prior to the formation of the raw synthesis gas.

The present invention relates to a method for producing synthesis gas, comprising a reforming step in a catalytic ceramic membrane reactor (RCMC).

Synthesis gas, co nsisting of compounds usable in refining or petrochemicals (hydrogen, carbon monoxide) and co-produced compounds (water, carbon dioxide, methane, etc.), is generally produced by reforming hydrocarbons (natural gas, liquefied petroleum gas or LPG, naphtha, petroleum residues) or coke; this reforming is a gradual oxidation, the oxidant being water vapor, carbon dioxide, oxygen, or a mixture containing at least two of the above oxidants.

The choice of oxidant depends on the types of hydrocarbon to be reformed, on the oxidants available, a nd on the H₂/CO ratio required in the synthesis gas, in order, after separation and purification, to supply the needs of the local mar ket for hydr ogen, carbon monoxide or in mixture thereof (s ynthesis gas for the synthesis of oxo alcohols, for example).

When oxygen is used as oxid ant (reforming of petroleum residues or coke, reforming of naphtha, or of lighter hydrocarbons when H₂ demand is low), the oxygen must be supplied under pressure (10 to 80×10⁵ Pa abs) and with high purity (over 95%), to avoid the costly removal of the inert gases (nitrogen and argon) in the synthesis gas or in the downstream processes.

In the case of reforming methods with oxygen, the cost of the oxygen accounts for a large share of the total production cost of the compounds present in the synthesis gas. The technology of catalytic ceramic membrane reactors (RCMC) allows the use of low pressure air (or of any other blend or mixture containing oxygen) as an oxygen source for hydrocarbon reforming, and eliminates the need to import (or produce) pressurized oxygen on site.

In a catalytic ceramic membrane reactor (RCMC), an oxidizing blend, also called oxidizing mixture, containing oxygen, is supplied to one side of the ceramic membrane, and a hydrocarbon feed, essentially methane, is supplied to the other side of the membrane. The ceramic membrane used is a hybrid conductor, both ionic and electronic, and has the particular feature that when subjected to a difference in oxygen partial pressure, it allows the O²⁻ ions to pass by an ion diffusion mechanism through the oxygen vacancies in the ceramic lattice. Thus the oxygen molecules are first ionized, and the ions then diffuse through the oxygen vacancies; the oxygen ions are then deionized and the oxygen molecules react with the hydrocarbon molecules to generate synthesis gas. The presence of a catalyst, based on Ni for example, allows a very fast reforming reaction and virtually complete depletion of the oxygen, on the hydrocarbon feed side.

The diffusion of the oxygen ions through the hybrid ceramic membranes is only effective at sufficiently high temperature, typically above 500° C., and the operating temperature must be even higher, typically above 700° C., in order to obtain a high oxygen flow; the flow of the oxygen ions through these ceramic membranes actually varies substantially with the temperature, and may have an exponential dependence on the temperature, according to the Arrhenius law.

A very large variety of hybrid conducting ceramic membranes are known today, particularly ceramics with a perovkite structure ABO₃, with dopants on the A and B sites such as AₓA′₁₋ₓB_{y}B′_{1-y}O_{3-δ} or AₓA′_{x′}A″_{1-x-x′}B_{y}B′_{y′}B″_{1-y-y′}O_{3-δ} (where A, A′, A″ are elements of groups 1, 2, 3 such as La, Sr, Ba, and B, B′, B″ are transition metals such as Fe, Co, Cr, Gd, etc.).

The catalytic ceramic membrane reactor may have a planar, tubular or monolithic configuration, and is preferably of a tubular or monolithic configuration to offer sufficient mechanical strength. The hybrid conducting ceramic membranes may also be self-supporting or may bear on porous supports to obtain higher oxygen flows.

A layer of catalyst may be deposited on the oxidant side to promote higher ionization rates of the oxygen molecules.

A method for producing synthesis gas is known from U.S. Pat. No. 6,077,323, using an RCMC in which the hydrocarbon feed is a mixture of methane-rich gaseous hydrocarbons to which one or more of the following constituents may be added: water, carbon dioxide, hydrogen, to form the RCMC feed gas. The gaseous hydrocarbon mixture is desulfurized but not pre-reformed before being introduced into the RCMC at a temperature between 510° C. and 760° C., this temperature depending on the composition of the mixture. The oxidizing mixture supplied to the RCMC is preheated to a temperature that is not more than 111° C. higher than the temperature of the feed gas supplied to the RCMC. The oxidizing mixture leaving the reactor, also called oxygen-depleted mixture or depleted mixture, has an RCMC outlet temperature higher than that of the oxidizing mixture entering the RCMC. The oxygen recovery rate in the oxidizing mixture supplied to the RCMC (that is, the percentage of oxygen consumed in the reactor) is at least 90%.

A further method for producing synthesis gas is known from U.S. Pat. No. 6,048,472, comprising an RCMC, different from the previous one in that the hydrocarbon mixture supplied to the method is pre-reformed in an adiabatic reactor or in a reformer heated with the synthesis gas produced, or in a conventional reformer with external heat input in a radiant furnace, and in that the oxidizing mixture supplied to the method is air, possibly depleted, produced by the direct combustion of heating gas in a combustion chamber in which the pressure is preferably lower than 0.69 bar (or 10⁵ Pa) gauge, or is depleted by mixing with the combustion gas with excess air from a radiant furnace.

However, the above characterizations present drawbacks in terms of field of application, capital investment, operating costs, and the cost of production of hydrogen and carbon monoxide, alone or in mixtures.

It is an object of the invention to propose a method and its application to remedy these drawbacks.

FCor this purpose, the invention relates to a method for producing synthesis gas containing hydrogen and carbon monoxide comprising the following steps:
a step (a) of pre-reforming of a hydrocarbon mixture,
a step (b) of reforming, in a catalytic ceramic membrane reactor (RCMC), of the pre-reformed mixture issuing from (a) by an oxidizing mixture containing oxygen to obtain raw synthesis gas containing hydrogen, carbon monoxide, carbon dioxide and water, and an oxygen-depleted mixture,
and steps of preheating of the various fluids used,
   characterized in that prior step (b), the oxidizing mixture is heated to a temperature between 871° C. and 1300° C., and preferably to a temperature of about 100° C.

Depending on each case, the method of the invention may comprise one or a plurality of the following features, considered separately or in all technically feasible combinations:
the hydrocarbon mixture issuing from step (a) is brought to a temperature at least 111° C. lower than that of the oxidizing mixture.

Thus the preheating of the oxidizing mixture to a higher temperature serves to offset the endothermic effect of the reforming in the inlet zone of the RCMC and to maintain the membrane temperature in this zone at a level compatible with high permeability, and serves to reduce the size of the RCMC and the corresponding investment.
the method includes a step of desulfurization of the hydrocarbon mixture prior to step (a).
the hydrocarbon mixture is desulforized, after the possible addition of hydrogen, at atemperature between 250° C. and 450° C., and preferably at a temperature of ob 400° C.
step (a) is carried out in a catalytic reactor at a temperature between 450 and 550° C., said reactor preferably being of the adiabatic type and the hydrocarbon mixture to be supplied to it is preheated to a temperature of 500° C.

Thus the method can be used to treat a mixture that may be natural gas, refinery or petrochemical waste gas, liquefied petroleum gas, naphtha, or any mixture of these various sources, containing methane and heavier hydrocarbons in any proportion.
the depleted mixture issuing from step (b) is at a lower temperature than that of the oxidizing mixture supplied to step (b), and the temperature difference is preferably at least 75° C.

Thus the oxidizing mixture is a vector of heat for the benefit of the RCMC. This produces a more favorable heat balance of the RCMC, with lower total oxidation of the hydrogen and carbon, that is, lower oxygen consumption, and lower production of water and carbon dioxide. This serves to reduce the quantity of oxidizing mixture supplied to the RCMC and hence the operating cost, or to increase the oxygen content in the depleted mixture and reduce the investment. For a given feed rate, this ensures increased production of carbon monoxide and hydrogen.
the temperature of the hydrocarbon mixture before step (b) is between 550 and 760° C., preferably 650° C.
the raw synthesis gas issuing from the RCMC is at a temperature between 800° C. and 1100° C., and the temperature of the depleted mixture is lower than that of said synthesis gas.
the method uses steps of cooling, separation and/or purification, and/or of treatment of the raw synthesis gas issuing from step (b).

Thus the raw synthesis gas is cooled by any means allowing recovery of the available sensible heat, and preferably a boiler for steam production, a heat exchanger incorporating a reforming catalyst. It is then cooled by countercurrent heat exchange with one or more fluids such as the hydrocarbon mixture, boiler water, deionized water, and possibly by heat exchange with the synthesis gas treatment modules located downstream. It is then treated to meet the specifications demanded by the market, in the modules for purification and separation of its various constituents, such as at least one decarbonation scrubber module and/or at least one module for adjustment of the H₂/CO ratio by permeation, and/or at least one module for hydrogen purification by selective adsorption.
the oxidizing mixture supplied to step (b) is obtained by treatment of an initial oxygenated gas mixture containing 10 to 50 molar % of oxygen.

The mixture can also contain, in a non-limiting manner, water vapor, carbon dioxide and inert gases such as nitrogen and argon. the mixture may consist in particular of air, enriched air from nitrogen production units, gas from combustion carried out with a large excess of air, combustion gas supplied to (or issuing from) a gas turbing, or a mixture of these gases.
the means employed for heat transfer during all or part of the steps of preheating of the various fluids of the method comprise at least one preheating furnace using the heat contained in the depleted mixture, and said furnace is also equipped with at least one postcombustion chamber.

The various fluids of the process means here: make-up deionized water, boiler water, the initial oxygenated mixture, the hydrocarbon mixture at the various stages of the method. The preheating steps also comprise the steps of steam generation and superheating, as well as those of the vaporization of liquid hydrocarbons. The postcombustion is advantageously supplied with heating gas and possibly with initial oxygenated gas to satisfy all the requirements of preheating, vaporization and heating of the various fluids of the method, and in order to control its total capacity independently of the operation of the RCMC reactor.
the oxidizing mixture is obtained by preheating the initial oxygenated gas mixture by heat exchange with the depleted mixture in a preheating furnace and/or by direct combustion of so-called primary heating gas and oxygen depletion of said initial oxygenated gas mixture in at least one combustion chamber.

The heating gas used is preferably the waste gas or gases generated by the modules for downstream treatment of raw synthesis gas which can be supplemented by modules using synthesis gas, and/or any fuel available near the unit.
according to one particular embodiment, the initial oxygenated gas is all or part of the combustion gas available at the outlet of a gas turbine present on site, under a pressure lower than 2×10^{[δ]} Pa (absolute), and at a temperature between 500 and 600° C.
according to another variant of the invention, the oxidizing mixture supplied to step (b) is all or part of the combustion gas available at the outlet of the combustion chamber of a gas turbine associated with the unit, under a pressure between 20 and 50×10^{δ} Pa abs and at a temperature between 1100 and 1300° C.
advantageously, the depleted mixture issuing from step (b) is supplied to the gas turbine for the cogeneration of electrical energy.
advantageously, the depleted mixture at the outlet of the gas turbine is supplied to the preheating furnace.
advantageously, the pre-reformed hydrocarbon mixture is supplied to step (b) at a pressure differing by not more than 10% from the pressure of the oxidizing mixture supplied to said step (b).
according to another variant of the invention, the oxidizing mixture supplied to step (b) is formed by all or part of a first combustion gas available at the outlet of a first combustion chamber supplied with a first fraction of combustible gas and with a first oxygenated gas, for example the combustion air available at the discharge of the air compressor of an associated gas turbine.
advantageously, the oxidizing mixture is available under a pressure between 20 and 50×10^{δ} Pa abs and at a temperature between 871 and 1100° C.
advantageously, the pre-reformed hydrocarbon mixture is supplied to step (b) at a pressure differing by not more than 10% from that of the oxidizing mixture.
advantageously, the depleted mixture issuing from step (b) is mixed with the unused portion of the first combustion gas to feed a second combustion chamber also supplied with a second portion of combustible gas.
advantageously, the second combustion gas issuing from the second combustion chamber is available under a pressure between 20 and 50×10^{δ} Pa and at a temperature between 1100° C. and 1300° C., independent of the operating temperature of the RCMC.
the second combustion gas issuing from the second combustion chamber is preferably expanded in the gas turbine to generate electricity.
the combustion gas issuing from the gas turbine is advantageously supplied to the preheating furnace.
according to another variant of the invention, the initial oxygenated gas is all or part of the waste gas from a unit producing nitrogen from air, containing 25 to 40 molar % of oxygen, available under a pressure above 1.6×10⁵ Pa abs and at ambient temperature.

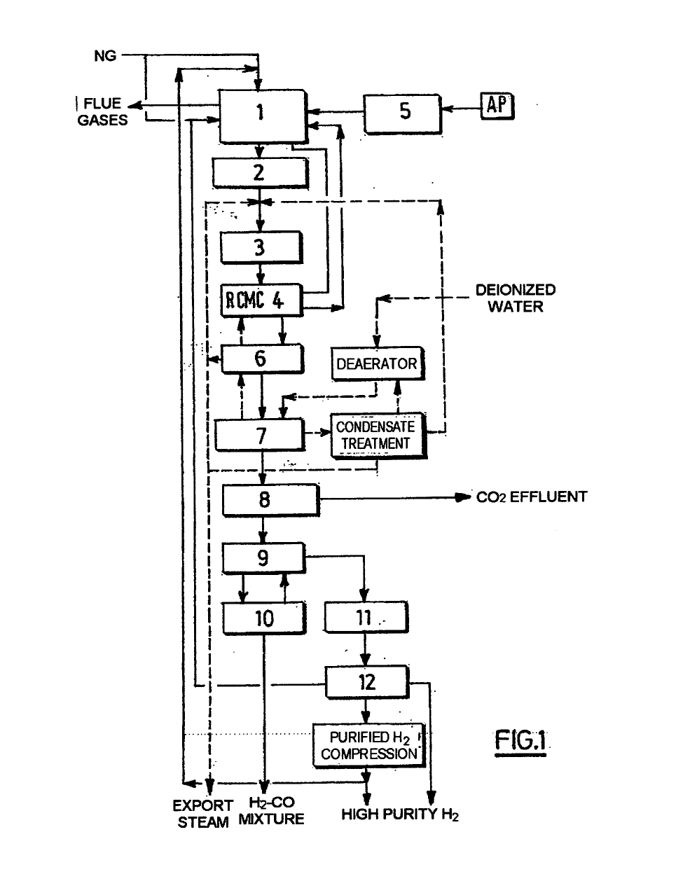

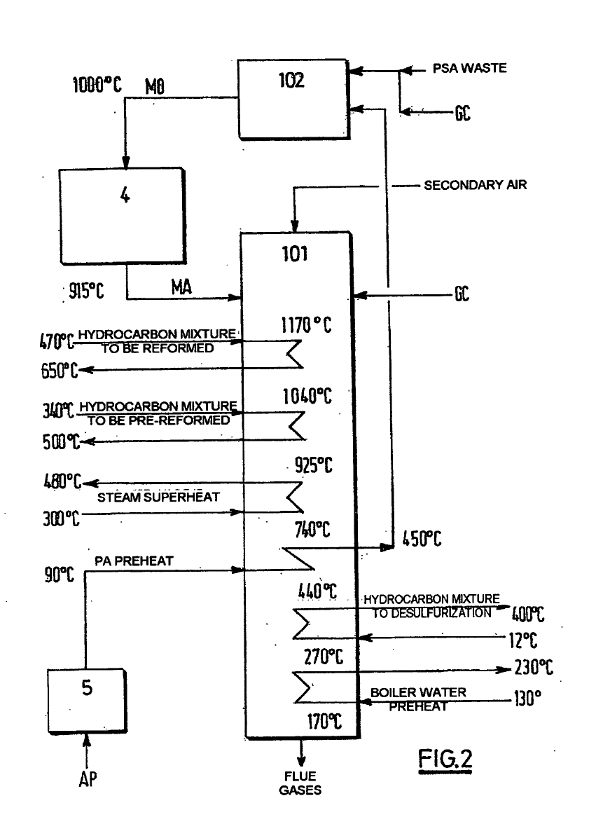

The invention will be better understood from a reading of the description that follows, of a method for producing a particular synthesis gas, given as a non-limiting example, with reference to FIG. 1 appended hereto. Various examples of preheating modules for putting this method into practice are also presented—the preheating module being the overall means for preheating the various fluids employed. The descriptions of these various examples are made with reference to FIGS. 2 to 6 appended hereto.

FIG. 1 schematically shows the various steps of a method for the simultaneous production, from a natural gas, of highly pure hydrogen and of H₂/CO mixture which can be used for the synthesis of oxo alcohols.

FIG. 2 shows a preheating module essentially comprising a preheating furnace and a combustion chamber suitable for putting the invention into practice.

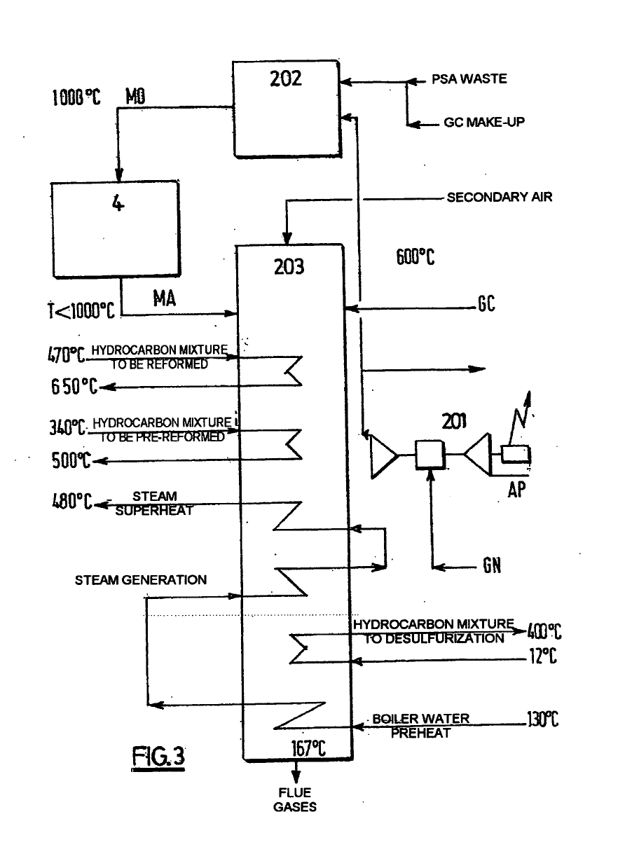

FIG. 3 shows a first variant of the preheating module incorporating an associated gas turbine.

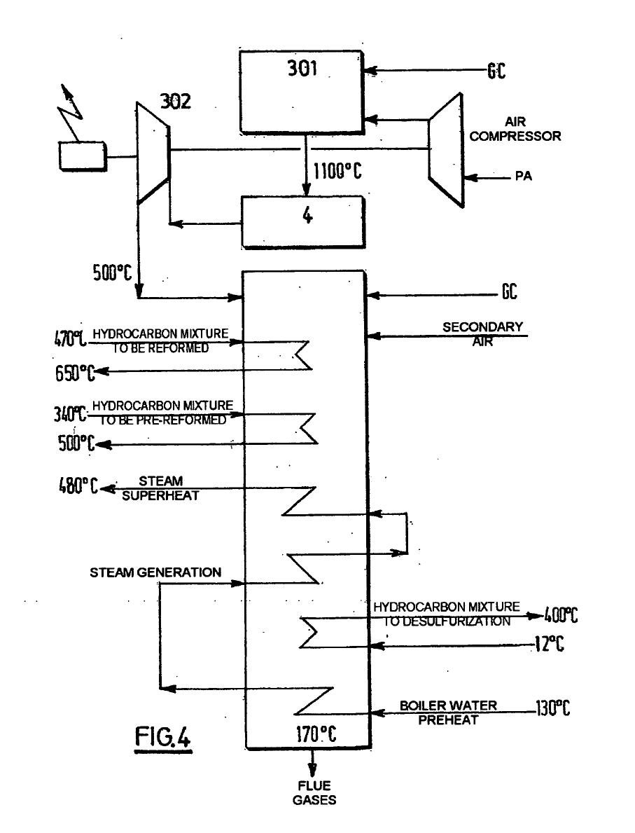

FIG. 4 shows a second variant integrating a gas turbine for the use of the preheating unit according to the invention.

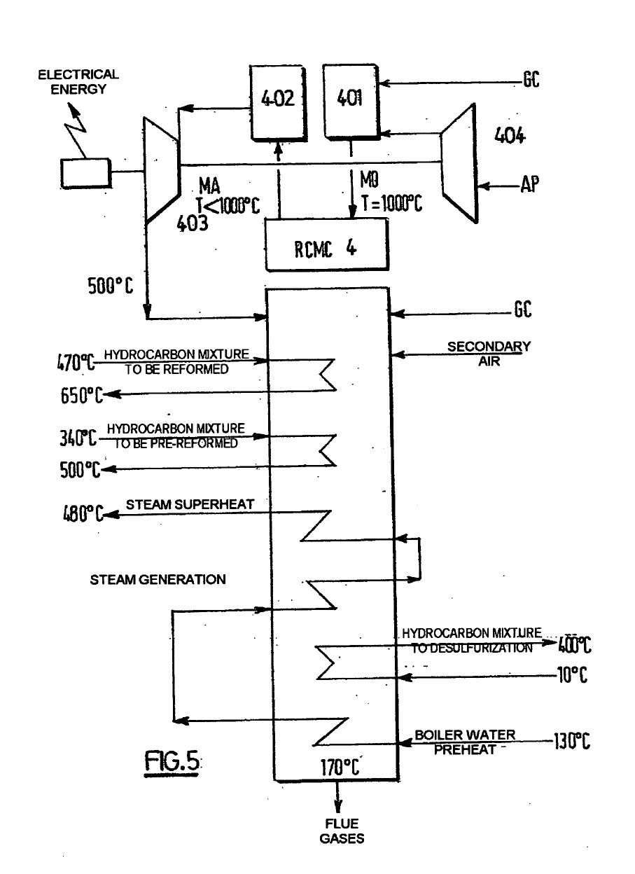

FIG. 5 shows a third variant incorporating a gas turbine for the use of the preheating unit according to the invention.

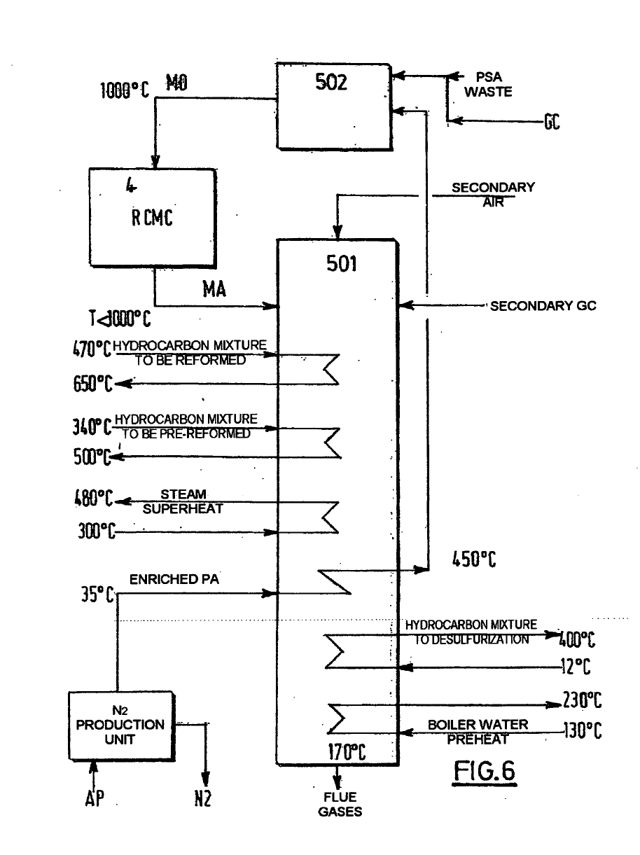

FIG. 6 shows another variant of the preheating module according to the invention, using a waste gas from a nitrogen production unit present on site.

As shown in FIG. 1, the hydrocarbon mixture supplied to the method consists of natural gas or GN, which, after the addition of hydrogen, is preheated to a temperature of about 400° C. in the preheating module 1 and is desulfurized by a conventional means 2 comprising a reactor for hydrogenation of the sulfur-bearing compounds and at least one reactor for hydrogen sulfide stripping on a zinc oxide bed. After the addition of steam, the desulfurized natural gas is preheated to a temperature of about 500° C. and is pre-reformed in an adiabatic reactor 3 containing a nickel-based catalyst. The pre-reformed mixture, a mixture of methane, hydrogen, carbon monoxide, carbon dioxide and water, is preheated to 650° C.; it is introduced into the reactor 4—catalytic ceramic membrane reactor or RCMC. The preheating steps which, with the exception of the first, are not shown in FIG. 1, are carried out in the associated preheating module (a representation of this module is described below with FIG. 2). Air or AP is used as initial oxygenated mixture, is compressed in a compressor 5 to a sufficient pressure to offset the pressure drops of the oxidizing mixture circuit, and is then preheated to about 1000° C. before being supplied to the RCMC. This preheating is carried out in the associated preheating module shown in FIG. 2. The oxidizing mixture or MO is obtained, and is then introduced into the RCMC.

In the RCMC, the oxidizing mixture MO is depleted of oxygen by giving up a part of this oxygen by permeation through the ceramic membrane. The depleted mixture MA available at the RCMC outlet is at a temperature of 925° C., and has a residual oxygen content of about 2%. The heat available in the mixture MA is then used in the preheating module.

A raw synthesis gas or GS, a product of the reforming of GN by oxygen extracted from the oxidizing mixture MO through the ceramic membrane and by the water present in the pre-reformed gas, is obtained at the outlet of the RCMC. The synthesis gas GS gives up its sensible heat in a boiler 6 generating steam in excess compared with the needs of the unit. It is then cooled in 7 by heat exchange with boiler water and deionized water, treated in a decarbonation module 8 to remove the carbon dioxide, and then sent to a drying module 9 to remove the water.

The gas GS is then treated in a permeation module 10 to extract a portion of the hydrogen through a polymer membrane and thereby produce a mixture with an H₂/CO ratio close to 1, an optimal ratio to supply a hydroformulation reactor and for the final production of oxo alcohols.

The hydrogen recovered in the permeate from the polymer membrane is used to regenerate the adsorbents of the drying module 9 and is compressed in a compressor 11 to supply a module 12 for selective adsorption on adsorbents (commonly called a PSA module) which allows the production of highly pure hydrogen. The waste gas from the module 12 is used as a heating gas in the preheating module.

The preheating module essentially comprises a preheating furnace and a combustion chamber. It will now be described according to several variants with reference to FIGS. 2 to 6.

FIG. 2 shows a preheating module in which the primary air AP used to generate the oxidizing mixture MO is compressed in an air compressor 5 to a pressure of about 2 10⁵ Pa abs. It is preheated to about 450° C. in the preheating furnace 101 and then superheated in a combustion chamber 102 to about 1000° C. by direct combustion of heating gas preferably consisting of waste fuel from the PSA module and make-up heating gas available on site, GC.

The oxidizing mixture MO, which leaves the combustion chamber at 1000° C., with an oxygen content of about 16 molar %, is then supplied to the RCMC 4. At the RCMC outlet, on completion of reforming, the depleted mixture MA is at a temperature of about 925° C. and has a residual oxygen content of about 2 molar %; this corresponds to an oxygen extraction rate of 87.5% in the RCMC reactor. The heat available in the mixture MA, supplemented by the heat from postcombustion using a secondary make-up heating gas GC and a secondary make-up air serves to satisfy all the needs of the unit, that is in particular:
to preheat the hydrocarbon mixture prior to its entry into the RCMC 4,
to preheat the hydrocarbon mixture prior to its entry into the pre-reformer,
to superheat the steam before its use inside or outside the unit,
to preheat the primary air AP prior to its entry into the combustion chamber 102,
to preheat the hydrocarbon mixture prior to its desulfurization,
to preheat the boiler water.

The presence of a postcombustion chamber, of which the operation, using heating gas and secondary air, is dissociated from the RCMC, serves to satisfy all the preheating needs of the unit and to control the preheating furnace 101 independently of the RCMC.

FIG. 3 shows a variant of the preheating module in which all or part of the primary air AP used to generate the oxidizing mixture MO is replaced by all or part of the effluent available at the outlet of a gas turbine 201, under a pressure lower than 2×10⁵ Pa abs and at a temperature between 450° C. and 700° C., and which typically contains between 10 and 15 molar % of oxygen. The effluent from the gas turbine is then superheated in the associated combustion chamber 202 to about 1000° C. by direct combustion of the heating gas preferably consisting of waste fuel from the PSA module and make-up heating gas available on site, GC.

The oxidizing mixture MO, leaving the combustion chamber 202 at 1000° C., with an oxygen content between 7 and about 12 molar %, is supplied to the RCMC 4. At the outlet of 4, on completion of reforming, the mixture MA is at a temperature of about 925° C. and has a residual oxygen content of about 2 molar %; this corresponds to an oxygen extraction rate between 71% and 84% in the RCMC; the heat available in MA, supplemented by the heat from postcombustion using a secondary make-up heating gas GC and a secondary make-up air, is supplied to the preheating furnace 203 and serves to satisfy all the needs of the unit, that is in particular:
to preheat the hydrocarbon mixture prior to its entry into the RCMC 4,
to preheat the hydrocarbon mixture prior to its entry into the pre-reformer,
to superheat steam before its use inside or outside of the unit,
to generate steam,
to preheat the hydrocarbon mixture prior to its desulfurization,
to preheat the boiler water.

The presence of a postcombustion chamber, of which the opearation using heating gas and secondary air is dissociated from the RCMC, serves to satisfy all the preheating needs of the unit and to control the preheating furnace 203 independently of the RCMC.

FIG. 4 shows a variant of the preheating module in which the RCMC 4 is supplied directly with all or part of the combustion gas available at the outlet of the combustion chamber 301 of a gas turbine 302, under a pressure between 10 and 25×10⁵ Pa abs., at a temperature between 871 and 1300° C., this combustion gas constituting an oxidizing mixture MO containing 10 to 15 molar % of oxygen. The RCMC 4 operates in this case under pressure. At the outlet, the depleted oxidizing mixture MA is at a pressure between 9 and 24×10⁵ Pa abs., at a temperature between 800 and 1200° C., and contains between 2 and 7 molar % of oxygen, which corresponds to an oxygen extraction rate between 30 and 87%. The depleted oxidizing mixture MA is then expanded in the gas turbine 302, coupled with the associated air compressor and with an electric power generator. The effluent available at the outlet of the turbine, under a pressure lower than 1.2×10⁵ Pa abs., is supplied to the preheating furnace 305, after the addition of a postcombustion using the waste fuel from the PSA module, a secondary make-up heating gas and a secondary make-up air. This serves to satisfy all the needs of the unit, that is in particular:
to preheat the hydrocarbon mixture prior to its entry into the RCMC 4,
to preheat the hydrocarbon mixture prior to its entry into the pre-reformer,
to superheat steam before its use inside or outside the unit,
to generate steam,
to preheat the hydrocarbon mixture prior to its desulfurization,
to preheat the boiler water.

The presence of a postcombustion chamber of which the operation using heating gas and secondary air is dissociated from the RCMC, serves to satisfy all the preheating needs of the unit and to control the preheating furnace independently of the RCMC.

FIG. 5 shows a variant of the preheating unit in which the oxidizing mixture MO supplied to the RCMC 4 consists of all or part of the combustion gas available at the outlet of a first combustion chamber 401 under a pressure between 10 and 25 bars abs., at a temperature between 871 and 1100° C., MO containing 10 to 15 molar % of oxygen. This first combustion chamber is supplied with a primary heating gas and with combustion air taken at the discharge of the compressor 404 coupled with a gas turbine 403. At the outlet of the RCMC, the depleted mixture MA is at a pressure between 9 and 24 bars abs., at a temperature between 800 and 1000° C. and contains between 2 and 7 molar % of oxygen, which corresponds to an oxygen extraction rate between 30 and 87%. The depleted mixture MA is then superheated in a second combustion chamber 402 to a temperature close to 1200° C. and expanded in the gas turbine. The effluent, available under a pressure lower than 1.2 bar abs, is supplied to the preheating furnace 405, and after addition of a postcombustion using the waste fuel from the PSA module of the unit, a secondary make-up heating gas and a secondary make-up air, serves to satisfy all the needs of the unit, that is in particular:
to preheat the hydrocarbon mixture prior to its entry into the RCMC,
to preheat the hydrocarbon mixture prior to its entry into pre-reformer,
to superheat steam before its use inside or outside the unit,
to generate steam,
to preheat the hydrocarbon mixture prior to its desulfurization,
to preheat the boiler water.

The presence of a postcombustion chamber of which the operation using heating gas and a secondary air is disslocated from the RCMC, serves to satisfy all the preheating needs of the unit and to control the preheating furnace independently of the RCMC.

FIG. 6 shows a variant of the preheating unit in which the air supplied to the synthesis gas production unit is oxygen-enriched air, and is in particular the waste gas from a nitrogen production unit, containing between 25 and 40 molar % oxygen. This enriched air, or enriched primary air, is preferably made directly available at a pressure above 1.6×10^{δ} Pa abs. It is preheated to about 450° C. in the preheating furnace 501, is then superheated in a combustion chamber 502 to a temperature preferably of about 1000° C. by direct combustion of heating gas, preferably consisting of waste fuel from the PSA madule and make-up heating gas available on site and thus forms the oxidizing mixture MO.

The oxidizing mixture, which has an oxygen content between 20 and about 35 molar %, is then supplied to the RCMC. At the RCMC outlet, the depleted mixture is at a temperature of 915° C. and has a residual oxygen content of about 2 molar %; this corrsponds to an oxygen extraction rate between 90 and 95% in the RCMC reactor; the heat available in the depleted mixture, supplemented by the heat from a postcombustion chamber using a secondary make-up heating gas and a secondary make-up air, serves to satisfy all the needs of the unit, that is in particular:
to preheat the hydrocarbon mixture prior to its entry into the RCMC,
to preheat the hydrocarbon mixture prior to its entry into the pre-reformer,
to superheat steam before its use inside or outside the unit,
to preheat the enriched air at the outlet of the nitrogen production unit,
to preheat the hydrocarbon mixture prior to its desulfurization,
to preheat the boiler water.

The presence of a postcombustion chamber of which the operation using heating gas and secondary air is dissociated from the RCMC, serves to satisfy all the preheating needs of the unit and to control the preheating furnace independently of the RCMC.

1-26. (canceled)

27. A method which may be used for producing a synthesis gas containing hydrogen and carbon monoxide, said method comprising:
a) pre-reforming a hydrocarbon mixture to obtain a first mixture;
b) reforming said first mixture with an oxidizing mixture to obtain a raw synthesis gas, wherein:
1) said oxidizing mixture comprising oxygen and is heated, prior to said reforming, to a temperature between about 871° C. and about 1300° C.;
2) said raw synthesis gas comprises:
i) hydrogen;
ii) carbon monoxide;
iii) carbon dioxide;
iv) water; and
v) an oxygen-depleted mixture; and
c) preheating the various steams used.

28. The method of claim 27, wherein said oxidizing mixture is heated, prior to said reforming, to a temperature of about 1000° C.

29. The method of claim 27, wherein said first mixture is brought to a temperature, prior to said reforming, at least about 111° C. lower than said temperature of said oxidizing mixture.

30. The method of 27, further comprising desulfurizing said hydrocarbon mixture prior to said pre-reforming.

31. The method of claim 30, wherein said hydrocarbon mixture is desulfurized at a temperature between about 250° C. and about 450° C.

32. The method of claim 31, further comprising adding hydrogen to said hydrocarbon mixture prior to said desulfurization.

33. The method of claim 31, wherein said temperature of said hydrocarbon mixture is about 400° C.

34. The method of claim 27, wherein said pre-reforming is preformed in a catalytic reactor at a temperature between about 450° C. and about 550° C.

35. The method of claim 34, wherein catalytic reactor is an adiabatic type catalytic reactor.

36. The method of 34, wherein said hydrocarbon mixture is preheated, prior to said pre-reforming, to atemperature of about 500° C.

37. The method of claim 27, wherein the temperature of said oxygen-depleted mixture is lower than said temperature of said oxidizing mixture.

38. The method of claim 37, wherein the difference between said temperature of said oxygen-depleted mixture and said temperature of said oxidizing mixture is at least about 75° C.

39. The method of claim 27, wherein the temperature of said first mixture is between about 550° C. and about 670° C.

40. The method of claim 39, wherein said temperature of said first mixture is about 650° C.

41. The method of claim 27, wherein:
a) said raw synthesis gas is at a temperature between about 800° C. and about 1100° C.; and
b) the temperature of said oxygen-depleted mixture is lower than said temperature of said synthesis gas.

42. The method of claim 27, further comprising:
a) cooling said raw synthesis gas; and
b) separating said raw synthesis gas.

43. The method of claim 42, further comprising purifying said raw syn otsis gas.

44. The method of claim 42, further comprising treating said raw synthesis gas.

45. The method of claim 27, wherein:
a) said oxidizing mixture is obtained through the treatment of a first oxygenated gas mixture; and
b) said first oxygenated gas mixture comprises between about 10 molar % and about 50 molar % of oxygen.

46. The method of claim 45, wherein:
a) said preheating said various streams comprises preheating with at least one preheating furnace;
b) said preheating furnace uses heat contained in said oxygen-depleted mixture; and
c) said preheating furnace comprises at least one post-combustion chamber.

47. The method of claim 46, wherein:
a) said oxidizing mixture is obtained by an oxidizing mixture production method; and
b) said production method comprises at least one member selected from the group consisting of:
1) preheating said first oxygenated gas by heat exchange with said oxygen-depleted mixture in said preheating furnace; and
2) directly combusting a primary heating gas with said first oxygenated gas in at least one combustion chamber.

48. The method of claim 47, wherein:
a) said first oxygenated gas is at least part of a combustion gas from an outlet of a gas turbine;
b) said combustion ga s a pressure less than about 2×10⁵ Pa abs; and
c) said combustion gas has a temperature between about 500° C. and about 600° C.

49. The method of claim 47, wherein:
a) said oxidizing mixture is at least part of a combustion gas from an outlet of combustion chamber associated withg a gas turbine;
b) said combustion gas has a pressure between about 20×10⁵ Pa abs and about 50×10⁵ Pa abs; and
c) said combustion gas has a temperature between about 1100° C. and about 300° C.

50. The method of claim 49, further comprising supplying said oxygen-depleted mixture to said gas turbine for the cogeneration of electrical energy.

51. The method of claim 50, further comprising supplying an oxygen-depleted mixture from an outlet of said turbine to said preheating furnace.

52. The method of claim 49, wherein the pressure of said first mixture differs from the pressure of said oxidizing mixture by less than about 10%.

53. The method of claim 47, wherein:
a) said oxidizing mixture comprises at least part of a first combustion gas;
b) said first combustion gas is supplied from an outlet of a first combustion chamber; and
c) said first combustion chamber is supplied with:
1) a first fraction of a combustible fluid; and
2) an oxygenated gas.

54. The method of claim 53, wherein said first combustion chamber is supplied with combustion air from an outlet of an air compressor turbine.

55. The method of claim 53, wherein:
a) said oxidizing mixture has a pressure between about 20×10⁵ Pa abs and about 50×10⁵ Pa abs; and
b) said oxidizing mixture has a temperature between about 871° C. and about 1100° C.

56. The method of claim 55, wherein the pressure of said first mixture differs from the pressure of said oxidizing mixture by less than about 10%.

57. The method of claim 53, further comprising:
a) mixing said oxygen-depleted mixture with at least part of said first combustion gas to create a second oxygenated feed gas; and
b) supplying said second oxygenated feed gas to a second combustion chamber, wherein said second combustion chamber is also supplied with a econd fraction of a combustible fluid.

58. The method of claim 57, wherein:
a) a second combustion gas is available from an outlet of said second combustion chamber;
b) said second combustion gas is at a pressure between about 20×10⁵ Pa abs and about 50×10⁵ Pa abs;
c) said second combustion gas is at a temperature between about 1100° C. and about 1300° C.; and
d) said temperature of said second combustion gas is independent of the operating temperature of said RCMC.

59. The method of claim 58, further comprising generating electricity by expanding said second combustion gas in a gas turbine.

60. The method of claim 59, wherein a combustion gas from an outlet of said gas turbine is supplied to said preheating furnace.

61. The method of claim 47, wherein:
a) said first oxygenated gas is at least part of a waste gas from an air separation unit;
b) said first oxygenated gas comprises about 25 molar % to about 40 molar % of oxygen;
c) said first oxygenated gas is at a pressure of at least about 1.6×10⁵ Pa abs; and
d) said first oxygenated gas is substantially at ambient temperature.
